(19) United States
(12) Patent Application Publication
(10) Pub. No.: US 2013/0309911 A1
(43) Pub. Date: Nov. 21, 2013

(54) Mobile High-Definition Link Converter

(71) Applicant: CHING-JEN HSU, Dongguan City (CN)

(72) Inventor: CHING-JEN HSU, Dongguan City (CN)

(21) Appl. No.: 13/476,367

(22) Filed: May 21, 2012

(51) Int. Cl. H01R 24/76

(52) U.S. Cl. 439/660

(57) ABSTRACT

A Mobile High-Definition Link converters for connecting with a MHL line with a HDTV or with a USB female socket of any electronic device, comprising a zinc alloy press molded shell, located in said shell by injection molding a rubber core and a press formed terminal assembly. The shell comprises of a High Definition Multimedia Interface (HDMI) female socket casing and a USB male socket casing connecting to each other. It is characterized in that, the rubber core and terminal assembly are fixed in a channel formed in the shell and are adapted for the HDMI female socket casing and the USB male socket casing.

### BACKGROUND OF THE INVENTION

1. Field of the Invention

The present invention relates to electrical connector technology, in particular, relates to an interface converter.

2. Description of the Related Art

In the increasing popular mobile Internet era, high definition (HD) portable media devices, such as Portable HD player is an inevitable trend. HD audio and video content stored on portable devices can be played directly in HD portable devices; however, with limitation of screen size, the user often cannot enjoy the full sound and visual enjoyment. Often, when the users wish to watch the HD media stored on portable devices, they usually transfer the high-definition audio and video content to high-definition TV, to enjoy high-quality sound and video. Thus, there is a popular a mobile high-definition link (MHL) came into the market. MHL is used as an interface link to transfer high-definition video and audio content stored in a portable device to HDTV playback. In general, HD portable devices comes with two accessories lines: a USB line for connecting to a computer or an AC power charger for charging the battery; and a MHL line for connecting to a HDTV for playing media content stored in the HD portable device. This not only increases the cost of sales of HD portable devices, but also inconvenience to the user to use and carry.

### SUMMARY OF THE INVENTION

The objective of this invention is to provide an interface converter that includes a MHL signal line and an interface converter for satisfying the demands for transferring HD media files to HDTV and while recharging the HD portable device at the same time.

The objective of the present invention can further understood through the following technical description: an MHL converter, including a zinc alloy press molded shell, located in said shell by injection molding a rubber core and a press formed terminal assembly. The shell comprises of a High Definition Multimedia Interface (HDMI) female socket casing and a USB male socket casing connecting to each other. It is characterized in that, the rubber core and terminal assembly are fixed in a channel formed in the shell and are adapted for the HDMI female socket casing and the USB male socket casing.

It is further characterized that the terminal assembly comprises a USB interface VCC terminal, a D− terminal, a D+ terminal and a ground terminal. The ground terminal is characterized by having a portion of the ground terminal body fixed inside of the HDMI female socket casing.

The ground terminal is further characterized by comprising a base part, a connection part and a contact part connecting together in the order thereof. Said base part and connection part are hidden inside of the rubber core, and said contact part, together with the D− terminal and D+ terminal are partially fixed inside of the HDMI female socket casing and to a side of the rubber core. Said VCC terminal is partially fixed inside of the HDMI female socket casing and to another side of the rubber core wherein, the contact part is positioned in between the D− terminal and VCC terminal.

It is further characterized that the contact part, D− terminal, and D+ terminal are partially fixed in the HDMI female socket casing and on the same plane with each other.

It is further characterized that the base part is perpendicular to the connection part on the same plane; the contact part is perpendicular to the connection part and is parallel to the base part; and the contact part is elevated from the plane of the base part and connection part.

It is further characterized that the contact part is parallel to the VCC terminal.

It is further characterized that the HDMI female socket casing is a type A HDMI female socket.

And it is further characterized that the USB male socket casing is a type A USB male socket.

The present invention devices the HDMI Female socket and the USB male into a converter shell, where the HDMI female socket and the USB male socket shares the same rubber core and terminal assembly. A user can use the MHL line to connect the portable HD media device with a HD television, as such, the high-definition audio and video can be transferred to the HDTV for playback. The present invention provides a MHL line converter, where a use can connect a MHL line to converter of present invention, with the USB male socket apparatus, the user then can connect the converter to an electronic device (such as computer or charger) for charging the portable HD media device. With this converter, users no longer need to carry two separate lines; only a MHL line and the converter, in this way not only reduces the product cost, but also increase the portability.

### BRIEF DESCRIPTION OF THE DRAWINGS

FIG. 1 is an external structural schematic diagram according to the first embodiment of the present invention.

FIG. 2 is a rubber core and terminal structural diagram according to the first embodiment of the present invention.

FIG. 3 is a rubber core and terminal structural diagram according to the first embodiment of the present invention from another angle.

FIG. 4 is a terminal assembly diagram according to the first embodiment of the present invention.

FIG. 5 is an overlooking schematic diagram of the terminal assembly according to the first embodiment of the present invention.

FIG. 6 is a side view schematic diagram of the terminal assembly according to the first embodiment of the present invention.

### DETAILED DESCRIPTION OF THE PREFFERED EMBODIMENT

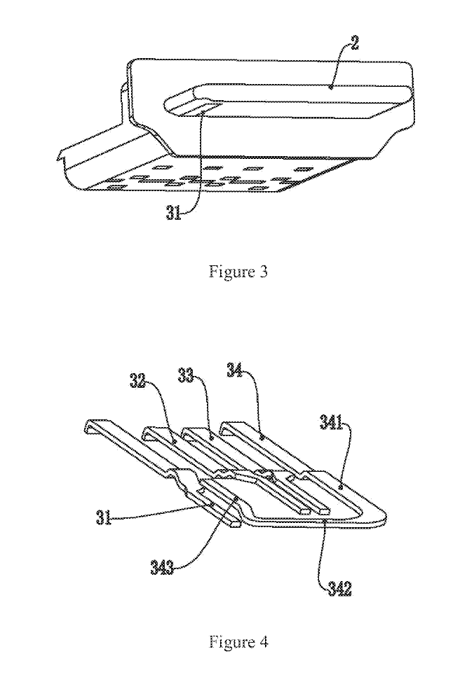

As illustrated in FIG. 1˜FIG. 3 the interface converter of present invention comprises a zinc alloy press molded shell 1, an injection molding rubber core 2 and a pressed formed terminal assembly 3 are inserted into shell 1. Whereas shell 1 comprises a HDMI female socket casing 11 connecting to a USB male socket casing 12. Furthermore, rubber core 2 and terminal assembly 3 are fixed in a channel formed inside the shell 1. Rubber core 2 and terminal assembly 3 being adapted to be used in HDMI female socket casing 11 and USB male socket 12 casing at same time. Zinc alloy press molded shell 1 provides a rigid structural characteristics, as well as to reducing electromagnetic interference.

A MHL line includes one plug-in end for connecting with a portable device, and another plug-in end for connecting with the HDMI female socket on a HDTV. Generally, a HDMI interface can be categorized in four types: Type A, B, C, and D. The HDMI female socket on a HDTV is a Type A, which is the same type as the HDMI female socket in this invention. The USB interface on computer or charging device generally is a Type A USB female socket, wherein the USB male socket in this invention is also a Type A.

The present invention incorporates a HDMI Female socket and a USB male socket into a converter, in which the shell 1, the rubber core 2 and the terminal assembly 3 are adapted for both the HDMI Female socket and the USB male socket. A user may use a MHL line for transferring the HD media files from a portable media device to a HDTV. The same user may also connect the MHL line to the converter of this invention to allow an instance adaption of MHL line to a USB female socket of electronic devices, such as computers and chargers.

By using a one step press form process in the production of the terminal assembly 3 allows the reduction of additional work to press form a HDMI terminal and a USB terminal and then welding them together. As a result, reduces production cost and improves work efficiency.

The invention adapts an insert molding process to produce the rubber core 2: by placing an already press formed terminal assembly 3 in a mold and then inject plastic material into the mold with the terminal 3 to finally form a rubber core 2 that retains the structural characteristics of a HDMI core and a USB core. With this process additional work on production of separate HDMI core and USB core can be reduced. As a result, reduces production cost and improves work efficiency.

With this design and process, the present invention of MHL converter needs just three sets of mould (shell 1 mold, terminal assembly 3 mold and rubber core 2 mold) to complete the product.

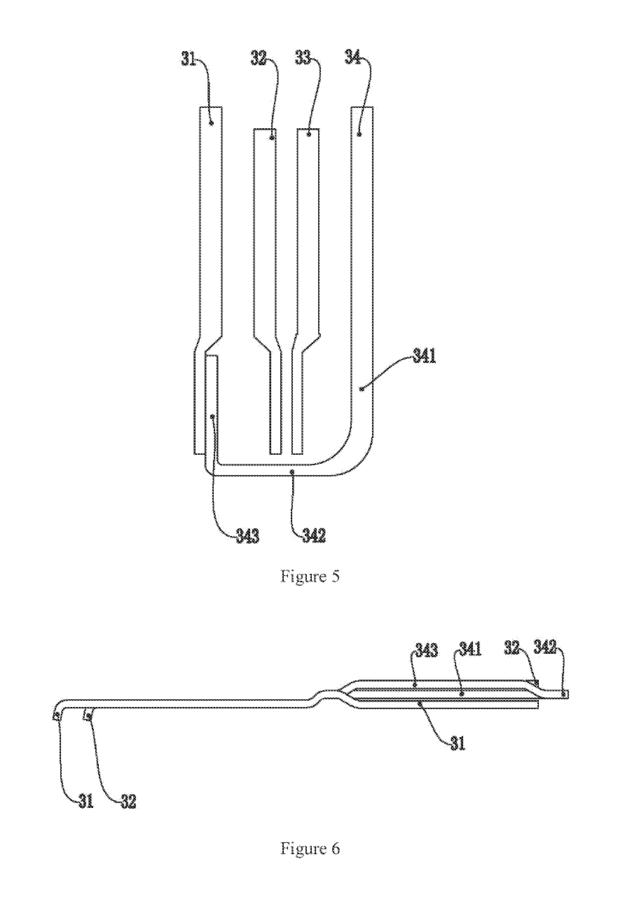

Refer to FIG. 4 and FIG. 5, the terminal assembly 3 comprises a USB interface VCC terminal 31, a D− terminal 32, a D+ terminal 33 and a GND terminal 34. The GND terminal 34 is partially fixed inside of the HDMI female socket casing 11. The GND terminal 34 is further characterized by comprising a base part 341, a connection part 342 and a contact part 343 connecting together in the order thereof. The base part 341 and connection part 342 are hidden inside of the rubber core 2, and the contact part 343, together with the D− terminal 32 and D+ terminal 33 are partially fixed inside of the HDMI female socket casing 11 and to a side of the rubber core 2. The VCC terminal 31 is partially fixed inside of the HDMI female socket casing 11 and to another side of the rubber core 2 wherein, the contact part 343 is positioned in between the D− terminal 32 and VCC terminal 31.

The contact part 343, D− terminal 32, and D+ terminal 33 are partially fixed inside of the HDMI female socket casing 22 and on the same plane with each other.

The base part 341 is perpendicular to the connection part 342 on the same plane; the contact part 343 is perpendicular to the connection part 342 and is paralle to the base part 341; and the contact part 343 is elevated from the plane of the base part 341 and connection part 342.

The contact part 343 is parallel to the VCC terminal 31.

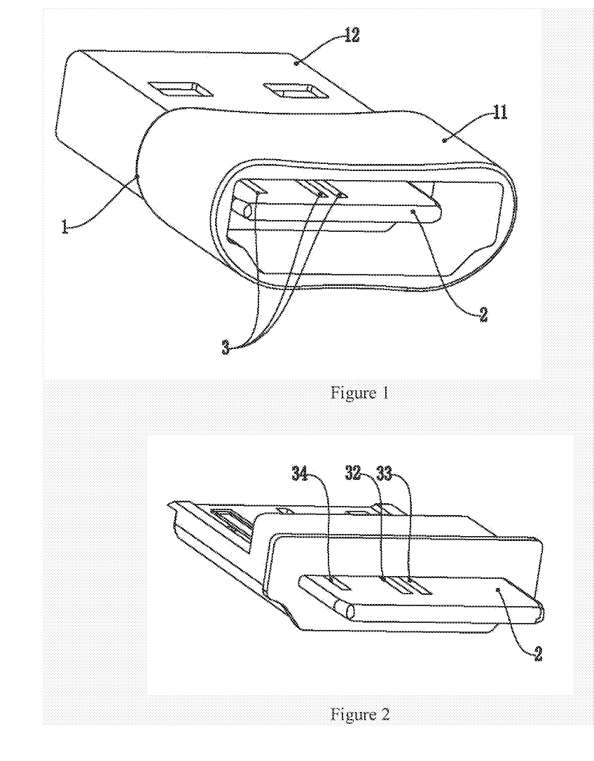

As illustrated in FIG. 4 and FIG. 5, terminal assembly 3 is partially fixed inside of the USB male socket casing and having an arrangement in the order of: VCC terminal 31, D− terminal 32, D+ terminal 33, and GND terminal 34. Terminal 3 is partially fixed inside of HDMI female socket casing 11 and in the rubber core 2; more specifically, as illustrated in FIG. 1 and FIG. 2, GND terminal 34 (contact part 343), D− terminal 32 and D+ terminal is fixed on one side of the rubber core 2 respectively; as illustrated in FIG. 3, VCC terminal 31 is fixed alone on the other side of the rubber core 2.

Because of the special design of GND terminal 34, where the base part 341 and connection part 342 are hidden inside of the rubber core 2, allows the GND terminal 34 to have different position is the HDMI female socket casing 11 and USB male socket casing 12. As such, depending on what the present invention of MHL converter is plug in with, the base part 341 and connection part 342 may or may not be conducted.

Finally, it should be understood that the above embodiment is only used to describe the technical solution of the present invention rather than limit the scope of protection of the present invention, the person of ordinary skill in this field should expect that any modification or equivalent replacement will fall in the scope of the invention.

1. A Mobile High-Definition Link converter comprises a zinc alloy press molded shell, an injection molding rubber core and a pressed formed terminal assembly are inserted into said shell; said shell comprises a HDMI female socket casing connecting to a USB male socket casing; said rubber core and terminal assembly are fixed in a channel formed inside the said shell; said rubber core and terminal assembly being adapted to be used in said HDMI female casing and USB male casing at same time.

2. The Mobile High-Definition Link converter as claimed in claim I wherein, it is characterized in that said terminal assembly comprises a USB interface VCC terminal, a D− terminal, a D+ terminal and a ground terminal; said ground terminal is fixed in the said HDMI Female casing and is comprised in sequence of a base part, a connection part and a contact part; said base part and connection part is hidden inside of said rubber core, and said contact part is partially fixed along with said D− terminal and D+ terminal inside of said HDMI female casing and to a side of said rubber core; said VCC terminal is partially fixed inside of said HDMI female casing and to a side of said rubber core; and wherein, said contact part is positioned in between said D− terminal and VCC terminal.

3. The Mobile High-Definition Link converter as claimed in claim 2 wherein, it is characterized that said contact part, D− terminal and D+ terminal are partially fixed inside and on the same plane of HDMI female socket casing.

4. The Mobile High-Definition Link converter as claimed in claim 2 wherein, it is characterized that said base part is perpendicular to said connection part on the same plane; said contact part is perpendicular to said connection part; and said contact part is parallel to base part; and said contact part is elevated from the plane of said base part and connection part.

5. The Mobile High-Definition Link converter as claimed in claim 2 wherein, said contact part is parallel to said VCC terminal.

6. The Mobile High-Definition Link converter as claimed in claim 1 or 2 wherein, said HDMI female socket is an A type HDMI female socket

7. The Mobile High-Definition Link converter as claimed in claim 1 or 2 wherein, said USB male socket is an A type USB male socket.
